(19) United States
(12) Patent Application Publication
(10) Pub. No.: US 2025/0226518 A1
(43) Pub. Date: Jul. 10, 2025

(54) Battery Cell, Energy Store and Method for Venting a Battery Cell

(71) Applicant: Bayerische Motoren Werke Aktiengesellschaft, Muenchen (DE)

(72) Inventors: Wonsup HAN, Suwon-si, Kwonsun-ku (KR); Hyunchul ROH, Muenchen (DE); Nina ZENSEN, Pfaffenhofen an der llm (DE)

(21) Appl. No.: 18/698,917

(22) PCT Filed: Sep. 8, 2022
(86) PCT No.: PCT/EP2022/075001

§ 371 Date: Apr. 5, 2024

(30) Foreign Application Priority Data
Oct. 27, 2021 (DE) 10 2021 127 935.6

(51) Int. Cl. H01M 50/342; H01M 50/107; H01M 50/131

(52) U.S. Cl. CPC H01M 50/342; H01M 50/107; H01M 50/131; H01M 2200/10

(57) ABSTRACT

A battery cell having a housing, which has a cover surface, a bottom surface and at least one lateral surface, and an auxiliary device which is at least partially arranged on the lateral surface and the bottom surface, are described. The housing has a recess at the bottom surface, and the auxiliary device completely covers the recess. Also described are an energy store and a method for venting a battery cell.

### BACKGROUND AND SUMMARY

A battery cell is specified. Furthermore, an energy store and a method for venting a battery cell of this kind are specified.

One object to be achieved is that of specifying a battery cell that is particularly safe. Furthermore, an energy store with battery cells of this kind and a method for venting a battery cell of this kind are to be specified.

These objects may be achieved by the subject-matter of the independent patent claims. Advantageous embodiments, implementations, and developments are the subject-matter of the dependent claims in each case.

According to at least one embodiment, the battery cell comprises a housing which comprises a top surface, a bottom surface, and at least one side surface. The top surface and the bottom surface are opposite one another, for example, and extend parallel to one another. The side surface connects the top surface and the bottom surface to one another.

The housing has, for example, a cylindrical shape. In this case, the housing comprises a single side surface, which has a ring shape in plan view. The battery cell extends along a main extent direction. The top surface and the bottom surface of the housing are arranged at ends of the battery cell, extending perpendicular to the main extent direction in each case.

A current collector can be arranged on the top surface and on the bottom surface, respectively. For example, an anode current collector may be arranged on the top surface and a cathode current collector may be arranged on the bottom surface, or vice versa.

The battery cell is, for example, an accumulator. The battery cell is therefore a single rechargeable storage element for electrical energy, for example.

The housing comprises, for example, a metal such as aluminum, for example. A thickness of the housing is, for example, at least 0.1 mm and at most 1 mm, for example, 0.5 mm.

According to at least one embodiment, the battery cell comprises an auxiliary device which is arranged at least partially on the side surface and the bottom surface. The auxiliary device is at least partially in direct contact with the side surface and the bottom surface.

For example, the auxiliary device is designed as a strip that extends along the main extent direction on the side surface. The strip has a length along the main extent direction and a width perpendicular to the main extent direction.

The length of the auxiliary device is, for example, at least 50%, in particular at least 80%, of a length of the side surface along the main extent direction. For example, the auxiliary device may extend over an entire length of the side surface.

The width of the auxiliary device is, for example, at most 10%, in particular at most 5%, of a circumference of the side surface perpendicular to the main extent direction. For example, the auxiliary device may not extend along the entire circumference of the side surface.

The auxiliary device comprises, for example, another metal that is different to the metal of the housing. A thickness of the auxiliary device is, for example, at least as great as the thickness of the housing.

Furthermore, the auxiliary device extends along the bottom surface. A portion of the auxiliary device on the side surface and a portion of the auxiliary device on the bottom surface are, in particular, integrally connected to one another.

According to at least one embodiment of the battery cell, the housing has a recess on the bottom surface. In this embodiment, the recess extends from an outer surface of the bottom surface and/or from an inner surface of the bottom surface along the main extent direction through the housing.

The recess has a round, oval, or polygonal shape perpendicular to the main extent direction. A maximum extent of the recess perpendicular to the main extent direction is smaller than a diameter of the housing. For example, the maximum extent is at most 10%, in particular at most 5%, the size of the diameter of the housing.

According to at least one embodiment of the battery cell, the auxiliary device completely covers the recess. In this embodiment, the auxiliary device extends up to the recess and completely covers it. In other words, the auxiliary device and the recess overlap, in particular completely.

One idea behind the present battery cell is, among other things, that the recess is not arranged in the side surface but in the bottom surface and is completely covered by means of an auxiliary device. In case of a malfunction of the battery cell, gas generated inside the battery cell particularly leads to an expansion of the side surface. Due to this kind of deformation, the recess is no longer covered by the auxiliary device and the gas can escape. This has the advantage of preventing the side surface of the housing from bursting open and therefore advantageously reduces damage to the adjacent battery cell.

According to at least one embodiment of the battery cell, the housing encloses a cavity in which a functional battery element is arranged. For example, the functional battery element comprises at least a first electrode layer, at least a separator layer, and at least a second electrode layer.

The first electrode layer is, for example, separated from the second electrode layer by the separator layer. The first electrode layer is, for example, formed with an active electrode material or from this material. In particular, the first electrode layer is formed with an active cathode material or from this material. In this case, the first electrode layer is a cathode layer of the battery cell.

The second electrode layer is, for example, formed with an active electrode material or from this material. In particular, the second electrode layer is formed with an active anode material or from this material. In this case, the second electrode layer is an anode layer of the battery cell.

The separator layer has a material that is permeable to lithium ions but impermeable to electrons. For example, the battery cell comprises another separator layer.

The functional battery element is, for example, wound. The wound functional battery element is arranged in the cavity. The housing and the functional battery element form the battery cell.

According to at least one embodiment of the battery cell, the recess penetrates the bottom surface at least partially. For example, a thickness of the housing in the recess is at least 50% smaller than the thickness of the housing without a recess.

According to at least one embodiment of the battery cell, the recess completely penetrates the bottom surface.

According to at least one embodiment of the battery cell, the cavity is completely encapsulated by the housing and the auxiliary device. In other words, the cavity may be completely surrounded in three dimensions by the housing and the auxiliary device. In this case, the auxiliary device seals the cavity in the region of the recess.

In particular, the cavity may be sealed by the auxiliary device in such a manner that the functional battery element is protected from external influences, such as hydrogen or oxygen, for example.

For example, the auxiliary device is in direct contact with the bottom surface in the region of the recess and closes the recess in a form-fitting manner. The auxiliary device has, for example, a sealing part that extends into the recess. The sealing part fills the recess at least partly or completely.

According to at least one embodiment of the battery cell, a material of the auxiliary device has a smaller coefficient of expansion than a material of the housing. For example, the coefficient of expansion of the material of the auxiliary device is smaller than the coefficient of expansion of the material of the housing for the same temperature range. The coefficient of expansion may be, in particular, a linear coefficient of expansion.

In this embodiment, the material of the auxiliary device is particularly advantageously a thermally stable material and is changed only slightly due to external influences, for example less than the material of the housing.

Furthermore, an energy store is specified that comprises a plurality of battery cells described here. Consequently, the features of the battery cell are also disclosed in conjunction with the energy store, and vice versa.

The battery cells are, for example, arranged at lattice points of a two-dimensional grid. In particular, the bottom surfaces and the top surfaces are arranged at the lattice points. The lattice may, for example, be a triangular grid, a square grid, or a hexagonal grid.

According to at least one embodiment of the energy store, the side surfaces of directly adjacent battery cells are opposite one another. The side surfaces of the battery cells all extend parallel to one another. The side surfaces may be in direct contact with directly adjacent side surfaces. Alternatively, a gap is arranged between directly adjacent side surfaces.

Furthermore, a method for venting a battery cell described here in the event of a malfunction of the battery cell is specified. Therefore, the features of the battery cell are also disclosed in conjunction with the method, and vice versa.

In the event of a malfunction of the battery cell, the energy stored in the battery cell can be released within a time interval. The time interval may be, for example, at most 100 ms, in particular at most 10 ms. In the event of a malfunction, for example, temperatures from at least 100° C. to around 400° C. occur, for example. With a malfunction of this kind, gas may be produced in the battery cell, for example, by at least partially vaporizing an electrolyte contained in the battery cell.

The side surface of the housing may expand in lateral directions, particularly due to the gas development during the malfunction. The resulting gas increases the temperature in the cavity, for example, and the gas pressure causes the housing to swell. In particular, the side surface is bent outwards in lateral directions by the gas pressure and increased temperature.

According to at least one embodiment of the method, the auxiliary device is displaced on the bottom surface in such a manner that the recess is no longer completely covered by the auxiliary device. Since the auxiliary device advantageously comprises a material with a smaller coefficient of expansion than the material of the housing, the auxiliary device does not expand like the housing. Due to this different expansion, the part of the auxiliary device on the bottom surface is displaced, so that the recess is no longer completely covered by the auxiliary device. This advantageously allows gas to escape via the recess.

According to at least one embodiment of the method, a cavity of the housing is enlarged during expansion. The cavity has, for example, a cylindrical shape before expansion. This cylindrical shape changes to a convex shape of the side surfaces during expansion.

According to at least one embodiment of the method, gas is generated in the cavity during the malfunction.

According to at least one embodiment of the method, the gas escapes from the cavity via the recess.

Exemplary embodiments of the invention are explained in greater detail below with reference to the schematic drawings.

### BRIEF DESCRIPTION OF THE DRAWINGS

FIG. 1 shows a schematic representation of a battery cell according to an exemplary embodiment, and

FIG. 2 shows a schematic representation of a method for venting a battery cell according to an exemplary embodiment.

Elements of the same construction or function are identified using the same reference signs across the figures.

### DETAILED DESCRIPTION OF THE DRAWINGS

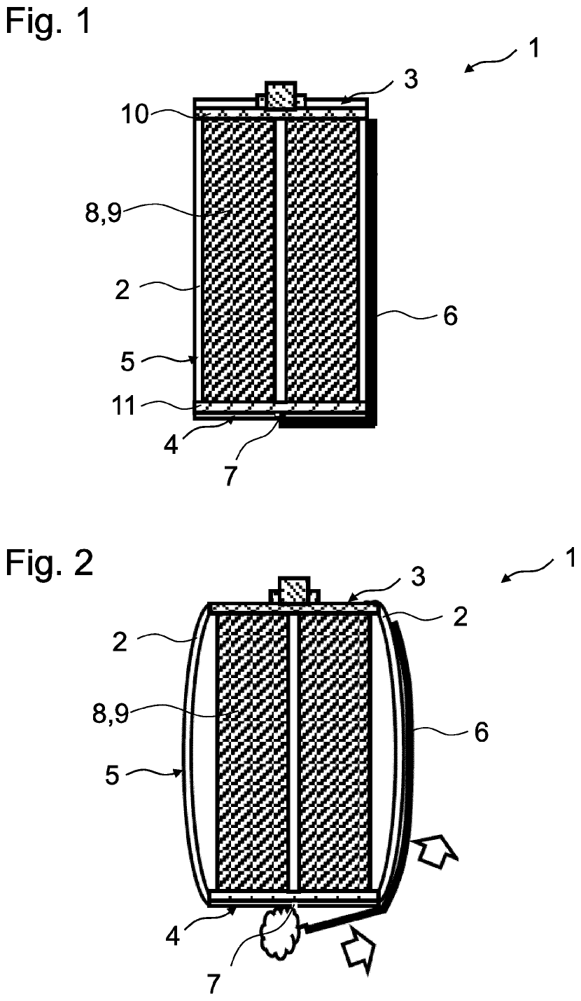

The battery cell 1 according to the exemplary embodiment in FIG. 1 comprises a housing 2, which comprises a top surface 3, a bottom surface 4, and a side surface 5, particularly a single cylindrical side surface 5. The housing 2 has a cylindrical shape and extends along a main extent direction. The top surface 3, the bottom surface 4, and the side surface 5 form a cavity 8. A functional battery element 9 is arranged in the cavity 8. The functional battery element 9 may be designed as a jelly roll, for example.

An anode current collector 10 of the battery cell 1 may be arranged between the functional battery element 9 and the top surface 3. The anode current collector 10 is contactable from the outside in an electrically conductive manner by means of a pin that completely penetrates the top surface 3. In other words, the top surface 3 comprises an opening through which the pin is guided to the anode current collector 10.

Furthermore, a cathode current collector 11 of the battery cell 1 may be arranged between the functional battery element 9 and the bottom surface 4. The cathode current collector 11 is contactable from the outside in an electrically conductive manner, for example by means of the housing 2. Alternatively, other arrangements of the current collectors are possible; for example, both the anode current collector and the cathode current collector may be arranged on the top surface.

The housing 2 has a recess 7 on the bottom surface 4, which completely penetrates the bottom surface 4. The recess 7 thereby forms a venting valve.

Furthermore, an auxiliary device 6 is arranged on the side surface 5 and on the bottom surface 4 of the housing 2. The auxiliary device 6 is in the form of a strip arranged on the side surface 5 and the bottom surface 4 of the housing 2. The strip extends completely along the side surface 5 along the main extent direction.

Furthermore, the auxiliary device 6 completely covers the recess 7. The recess 7 is also completely filled with a material of the auxiliary device 6.

The cavity 8 is completely sealed by the auxiliary device 6, the top surface 3, the bottom surface 4, and the side surface 5. In other words, the functional battery element 9 is advantageously protected from an environment surrounding the battery cell 1.

With the method according to the exemplary embodiment in FIG. 2, the battery cell 1 suffers a malfunction. In the event of a malfunction of the battery cell 1, the energy stored in the battery cell 1 can be released, causing temperatures of over 400° C. to occur. An electrolyte contained in the cavity 8 of the battery cell and/or the functional battery element 9 of the battery cell 1 may become at least partially gaseous at temperatures of this kind.

The cavity 8 is enlarged by a gas of this kind and temperatures of this kind. In particular, the side surface 5 of the housing 2 expands outwards in lateral directions. The side surface 5 therefore expands.

The auxiliary device 6 comprises a material that has a smaller coefficient of expansion than the material of the housing 2. Therefore, the auxiliary device 6 does not expand to the same extent as the housing 2.

Due to this different expansion, the auxiliary device 6 is displaced on the bottom surface 4 in such a manner that the recess 7 is no longer completely covered by the auxiliary device 6. In this way, gas can advantageously escape via the recess 7. The gas is depicted symbolically as a cloud in FIG. 2. The arrows correspond to a displacement of the auxiliary device 6.

### LIST OF REFERENCE SIGNS

1 Battery cell
2 Housing
3 Top surface
4 Bottom surface
5 Side surface
6 Auxiliary device
7 Recess
8 Cavity
9 Functional battery element
10 Anode current collector
11 Cathode current collector

1-10. (canceled)

11. A battery cell comprising:
a housing having a top surface, a bottom surface, and at least one side surface, and
an auxiliary device arranged at least partially on the side surface and the bottom surface, wherein
the housing has a recess on the bottom surface, and
the auxiliary device completely covers the recess.

12. The battery cell according to claim 11, wherein the auxiliary device is configured, upon a malfunction of the battery cell and expansion of the at least one side surface of the housing in a lateral direction, to be displaced such that the recess is no longer completely covered by the auxiliary device.

13. The battery cell according to claim 11, wherein
the housing encloses a cavity in which a functional battery element is arranged.

14. The battery cell according to claim 11, wherein
the recess penetrates the bottom surface at least partially.

15. The battery cell according to claim 11, wherein
the recess completely penetrates the bottom surface.

16. The battery cell according to claim 13, wherein
the cavity is completely encapsulated by the housing and the auxiliary device.

17. The battery cell according to claim 11, wherein
a material of the auxiliary device has a smaller coefficient of expansion than a material of the housing.

18. An energy store having:
a plurality of battery cells according to claim 11, wherein
the side surfaces of directly adjacent battery cells are opposite one another.

19. A method for venting a battery cell according to claim 11 in the event of a malfunction of the battery cell, the method comprising:
upon expansion of the side surface of the housing in a lateral direction,
displacing the auxiliary device on the bottom surface in such a manner that the recess is no longer completely covered by the auxiliary device.

20. The method according to claim 19, wherein
a cavity of the housing is enlarged during the expansion.

21. The method according to claim 19, wherein
gas is generated in the cavity during the malfunction, and
the gas escapes from the cavity via the recess.
